(19) United States
(12) Patent Application Publication
(10) Pub. No.: US 2015/0206420 A1
(43) Pub. Date: Jul. 23, 2015

(54) ALARM SYSTEM

(71) Applicants: HONG FU JIN PRECISION INDUSTRY (WuHan) CO., LTD., Wuhan (CN); HON HAI PRECISION INDUSTRY CO., LTD., New Taipei (TW)

(72) Inventors: YI-LIANG LI, Wuhan (CN); QIANG LI, Wuhan (CN); LI-PING FAN, Wuhan (CN); YU-LIN LIU, Wuhan (CN)

(21) Appl. No.: 14/524,911

(22) Filed: Oct. 27, 2014

(30) Foreign Application Priority Data
Jan. 22, 2014 (CN) 201410029058.9

(51) Int. Cl. G08B 25/10

(52) U.S. Cl. CPC G08B 25/10

(57) ABSTRACT

An alarm system includes a wireless signal generating module configured to be mounted in an electronic device, a wireless signal receiving module, a processing module coupled to the wireless signal receiving module, a drive circuit coupled to the processing module, and an alarm device coupled to the drive circuit. The wireless signal generating module communicates with the wireless signal receiving module wirelessly when within a communication range of the wireless signal receiving module. The wireless signal generating module does not communicate with the wireless signal receiving module wirelessly when out of the communication range with the wireless signal receiving module, thereby the processing module sends a connection signal to the drive circuit. The drive circuit drives the alarm device to give an alarm when receiving the connection signal.

### CROSS-REFERENCE TO RELATED APPLICATIONS

This application claims priority to Chinese Patent Application No. 201410029058.9 filed on Jan. 22, 2014, the contents of which are incorporated by reference herein.

### FIELD

The subject matter herein generally relates to an alarm system for an electronic device.

### BACKGROUND

An alarm system is used to protect an electronic device.

### BRIEF DESCRIPTION OF THE DRAWINGS

Implementations of the present technology will now be described, by way of example only, with reference to the attached figures.

FIG. 1 is a block diagram of one embodiment of an alarm system for an electronic device.

FIG. 2 is a circuit diagram of the alarm system of FIG. 1.

FIG. 3 is a flowchart of the alarm system of FIG. 1.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, components have not been described in detail so as not to obscure the related relevant feature being described. Also, the description is not to be considered as limiting the scope of the embodiments described herein. The drawings are not necessarily to scale and the proportions of certain parts have been exaggerated to better illustrate details and features of the present disclosure.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “comprising,” when utilized, means “comprising, but not necessarily limited to”; it specifically indicates open-ended inclusion or membership in the so-described combination, group, series and the like.

The present disclosure is described in relation to an alarm system for an electronic device.

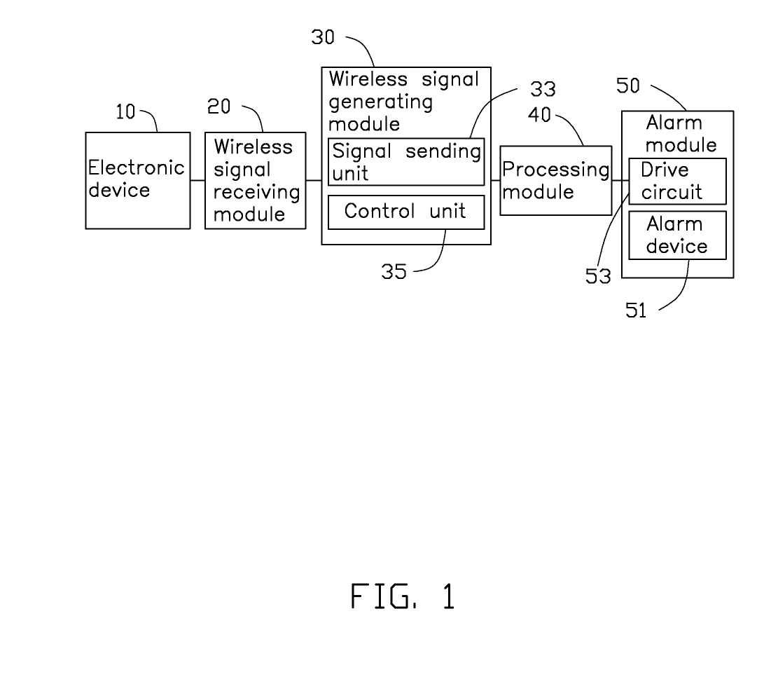

FIG. 1 illustrates an embodiment of an alarm system for an electronic device 10. The alarm system comprises a wireless signal receiving module 20 mounted in the electronic device 10, a wireless signal generating module 30, a processing module 40 coupled to the wireless signal receiving module 20, and an alarm module 50 coupled to the processing module 40. The wireless signal generating module 30 can communicate with the wireless signal receiving module 20 wirelessly when within a communication range with the wireless signal receiving module 20. In one embodiment, the electronic device 10 can be a notebook computer or an all-in-one (AIO) computer.

FIG. 1 illustrates that the wireless signal generating module 30 comprises a signal sending unit 33 and a control unit 35; the signal sending unit 33 is configured for sending communication signals. In one embodiment, the wireless signal generating module 30 is a BLUETOOTH® signal generating module; the signal sending unit 33 is a 51-series single-chip, each communication signal is a BLUETOOTH® signal; the control unit is a 555 series timer and is configured to control the signal sending unit 33 to send the periodical communication signals.

The wireless signal receiving module 20 is configured to receive the communication signal from the signal sending unit 33 to communicate with the wireless signal generating module 30. In one embodiment, the wireless signal receiving module 20 is a BLUETOOTH® signal receiving module and is a 51-series single-chip.

The processing module 40 is configured to send a disconnection signal to the alarm module 50 when the wireless signal receiving module 20 communicates with the wireless signal generating module 30. The processing module 40 is configured to send a connection signal to the alarm module 50 when the wireless signal receiving module 20 does not communicate with the wireless signal generating module 30. In one embodiment, the processing module 40 is a microprocessor and a type of the processing module 40 is AT89C2051; the communication signal is a pulse width modulation (PWM) signal.

The alarm module 50 comprises an alarm device 51 and a drive circuit 53 for driving the alarm device 31. The drive circuit 53 comprises a first connection member 55, a second connection member 57, a first diode D1, and a second diode D2. In one embodiment, the alarm device 51 is a buzzer; each first connection member 55 and second connection member 57 is a clad pipe; the first connection member 55 comprises a first triode Q1 and a second triode Q2; and the second connection member 57 comprises a third triode Q3 and a fourth triode Q4.

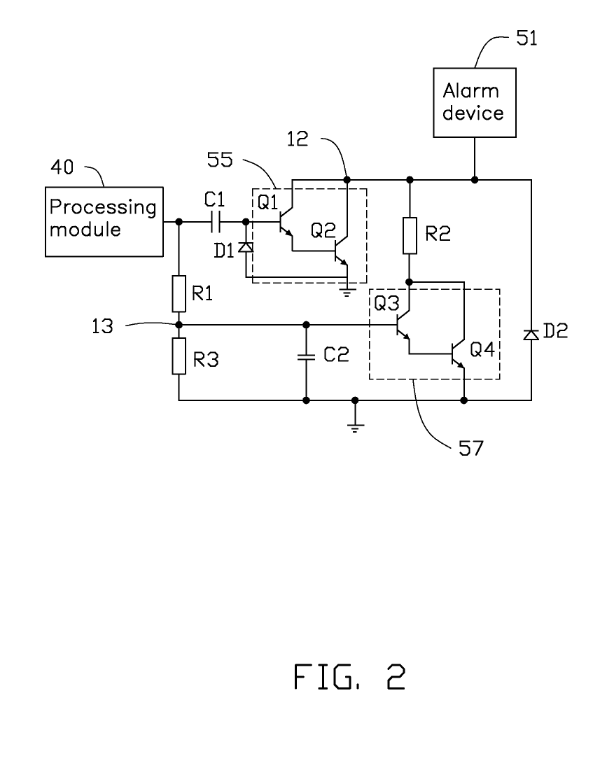

FIG. 2 illustrates that the processing module 40 is coupled to an anode of a first capacitor C1, the anode of the first capacitor C1 is coupled to one end of a first resistor R1. A cathode of the first capacitor C1 is coupled to a base of the first triode Q1. A collector of the first triode Q1 and a collector of the second triode Q2 are coupled to a first node 12. An emitter of the first triode Q1 is coupled to the base of the second triode Q2. An emitter of the second triode Q2 is grounded. The base of the first triode Q1 is coupled to an anode of the first diode D1. A cathode of the first diode Dl is grounded. The other end of the first resistor R1 is coupled to a second node 13. The second node 13 is coupled to a base of the third triode Q3. A collector of the third triode Q3 is coupled to the first node 12 via a second resistor R2. An emitter of the third triode Q3 is coupled to a base of the fourth triode Q4. An emitter of the fourth triode Q4 is grounded. The first node 12 is coupled to an anode of the second diode D2. A cathode of the second diode D2 is grounded. The second node 13 is grounded via a third resistor R3. The second node 13 is grounded via a second capacitor C2. The first node 12 is coupled to the alarm device 51.

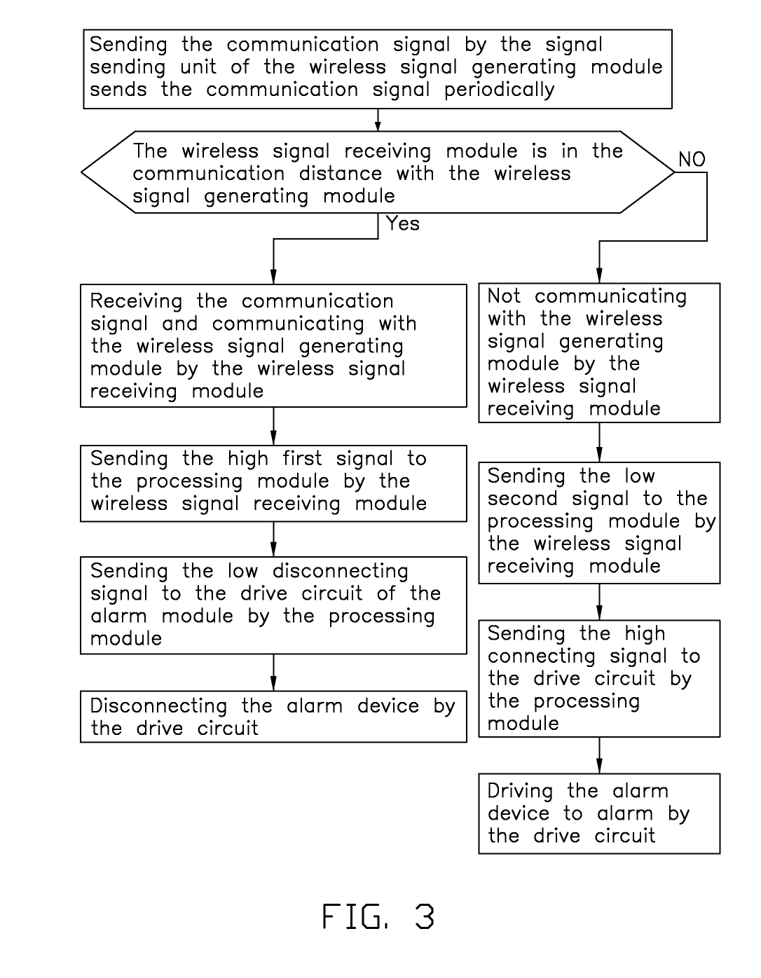

FIG. 3 illustrates that the working principle of the alarm system is that the signal sending unit 33 of the wireless signal generating module 30 sends the communication signal periodically. The wireless signal receiving module 20 communicates with the wireless signal generating module 30 when within the communication range of the wireless signal generating module 30. The wireless signal receiving module 20 sends a high first signal to the processing module 40. The processing module 40 sends a low disconnection signal to the drive circuit 53 of the alarm module 50 after receiving the first signal. The drive circuit 53 disconnects the alarm device 51 after receiving the disconnection signal. The wireless signal receiving module 20 does not communicate with the wireless signal generating module 30 when out of the communication range with the wireless signal generating module 30. The wireless signal receiving module 20 sends a low second signal to the processing module 40. The processing module 40 sends a high connection signal to the drive circuit 53 after receiving the second signal. The drive circuit 53 drives the alarm device 51 to sound an alarm after receiving the disconnection signal.

It is to be understood that even though numerous characteristics and advantages have been set forth in the foregoing description of embodiments, together with details of the structures and functions of the embodiments, the disclosure is illustrative only and changes may be made in detail, especially in the matters of shape, size, and arrangement of parts within the principles of the disclosure to the full extent indicated by the broad general meaning of the terms in which the appended claims are expressed.

What is claimed is:

1. An alarm system comprising:
a wireless signal generating module;
a wireless signal receiving module;
a processing module;
a drive circuit coupled to the processing module; and
an alarm device coupled to the drive circuit,
wherein, the wireless signal generating module does not communicate with the wireless signal receiving module wirelessly when out of a communication range with the wireless signal receiving module;
wherein, the processing module sends a connection signal to the drive circuit when the wireless signal generating module does not communicate with the wireless signal receiving module wirelessly; and
wherein, the drive circuit drives the alarm device to give an alarm when receiving the connection signal.

2. The alarm system of claim 1, wherein the wireless signal generating module communicates with the wireless signal receiving module wirelessly when being the communication range with the wireless signal receiving module, the wireless signal receiving module sends a first signal to the processing module, thereby the processing module sends a disconnection signal to the drive circuit, thus the drive circuit disconnects the alarm device after receiving the disconnection signal.

3. The alarm system of claim 1, wherein the wireless signal receiving module sends a second signal to the processing module when not communicating with the wireless signal generating module, and the processing module sends a connection signal to the drive circuit after receiving the second signal.

4. The alarm system of claim 1, wherein the drive circuit comprises a first connection member and a second connection member; the first connection member comprises a first triode and a second triode, the processing module is coupled to a base of the first triode, a connector of the first triode is coupled to a connector of the second triode and the alarm device, an emitter of the first triode is coupled to the base of the first triode, and an emitter of the second triode is grounded.

5. The alarm system of claim 4, wherein the second connection member comprises a third triode and a fourth triode, the processing module is coupled to a base of the third triode, a connector of the third triode is coupled to a connector of the fourth triode and the alarm device, an emitter of the third triode is coupled to the base of the third triode, and an emitter of the fourth triode is grounded.

6. The alarm system of claim 5, wherein the processing module is coupled to the base of the third triode via a resistor.

7. The alarm system of claim 5, wherein a first diode is coupled between the emitter of the fourth triode and the alarm device.

8. The alarm system of claim 4, wherein the processing module is coupled to the emitter of the fourth triode via a capacitor.

9. The alarm system of claim 4, wherein a second diode is coupled between the base of the first triode and the emitter of the second triode.

10. The alarm system of claim 1, wherein the communication signal is a BLUETOOTH® signal.

11. An alarm system comprising:
a wireless signal generating module configured to be mounted in an electronic device;
a wireless signal receiving module;
a processing module coupled to the wireless signal receiving module;
a drive circuit coupled to the processing module; and
an alarm device coupled to the drive circuit,
wherein, the wireless signal generating module can communicate with the wireless signal receiving module wirelessly when being in a communication range with the wireless signal receiving module;
wherein, the wireless signal generating module can not communicate with the wireless signal receiving module wirelessly when out of the communication range with the wireless signal receiving module;
wherein, the processing module sends a connection signal to the drive circuit when the wireless signal generating module does not communicate with the wireless signal receiving module wirelessly; and
wherein, the drive circuit drives the alarm device to give an alarm when receiving the connection signal.

12. The alarm system of claim 11, wherein the first signal is a high level signal.

13. The alarm system of claim 11, wherein the wireless signal receiving module sends a first signal to the processing module when communicating with the wireless signal generating module, the processing module sends a disconnection signal to the drive circuit after receiving the first signal, and the drive circuit disconnects the alarm device after receiving the disconnection signal.

14. The alarm system of claim 13, wherein the wireless signal receiving module sends a second signal to the processing module when not communicating with the wireless signal generating module, and the processing module sends a connection signal to the drive circuit after receiving the second signal.

15. The alarm system of claim 14, wherein the drive circuit comprises a first connection member and a second connection member; the first connection member comprises a first triode and a second triode, the processing module is coupled to a base of the first triode, a connector of the first triode is coupled to a connector of the second triode and the alarm device, an emitter of the first triode is coupled to the base of the first triode, and an emitter of the second triode is grounded.

16. The alarm system of claim 15, wherein the second connection member comprises a third triode and a fourth triode, the processing module is coupled to a base of the third triode, a connector of the third triode is coupled to a connector of the fourth triode and the alarm device, an emitter of the third triode is coupled to the base of the third triode, and an emitter of the fourth triode is grounded.

17. The alarm system of claim 16, wherein the processing module is coupled to the base of the third triode via a resistor.

18. The alarm system of claim 15, wherein a diode is coupled between the base of the first triode and the emitter of the second triode.

19. The alarm system of claim 15, wherein the first connection member is a clad pipe.

20. The alarm system of claim 11, wherein wireless signal generating module comprises a signal sending unit configured to send the communication signal and a control unit configured to control the signal sending unit to send the communication signal periodically.
